(19) United States
(12) Patent Application Publication
(10) Pub. No.: US 2017/0286087 A1
(43) Pub. Date: Oct. 5, 2017

(54) SETTING EXECUTION SYSTEM, AND RECORDING MEDIUM THEREFOR, THAT ENSURE IMPROVED APPROPRIATENESS OF APPLYING SETTING INFORMATION TO ELECTRONIC DEVICE

(71) Applicant: KYOCERA Document Solutions Inc., Osaka (JP)

(72) Inventor: Tomonori NAOTA, Osaka (JP)

(73) Assignee: KYOCERA Document Solutions Inc., Osaka (JP)

(21) Appl. No.: 15/431,189

(22) Filed: Feb. 13, 2017

(30) Foreign Application Priority Data
Apr. 4, 2016 (JP) 2016-075173

(51) Int. Cl. G06F 9/445; H04N 1/00; G06F 9/44; H04L 29/08

(52) U.S. Cl. CPC G06F 8/65; H04L 67/18; H04N 1/0097; H04N 1/00973; G06F 8/71; H04N 2201/0094; H04N 2201/0039

(57) ABSTRACT

A setting execution system according to an aspect of the disclosure includes an information applying unit, an information managing unit, a target device position acquisition unit, a candidate determining unit, a candidate display, and a designation accepting unit. The information managing unit manages registered device information as the information associated with a registered device position as a position of a registered device. The candidate determining unit identifies the registered device information for the registered device that exists at a position within a certain range from the target device based on: the registered device position managed by the information managing unit associated with the registered device information; and the target device position obtained by the target device position acquisition unit. The candidate determining unit determines the candidate based on the identified registered device information.

### INCORPORATION BY REFERENCE

This application is based upon, and claims the benefit of priority from, corresponding Japanese Patent Application No. 2016-075173 filed in the Japan Patent Office on Apr. 4, 2016, the entire contents of which are incorporated herein by reference.

### BACKGROUND

Unless otherwise indicated herein, the description in this section is not prior art to the claims in this application and is not admitted to be prior art by inclusion in this section.

There is known a typical system that applies setting information, corresponding to an installation region of an electronic device, to the electronic device.

### SUMMARY

A setting execution system according to an aspect of the disclosure includes an information applying unit, an information managing unit, a target device position acquisition unit, a candidate determining unit, a candidate display, and a designation accepting unit. The information applying unit applies information including setting information that indicates a setting for an electronic device to the electronic device. The information managing unit manages the information. The target device position acquisition unit obtains a target device position as a position of a target device, the target device corresponding to the electronic device to which the information is applied by the information applying unit. The candidate determining unit determines a candidate of the information applied to the target device. The candidate display displays the candidate determined by the candidate determining unit. The designation accepting unit accepts any of designation of the candidates displayed by the candidate display. The information applying unit applies the candidate corresponding to the designation accepted by the designation accepting unit to the target device. The information managing unit manages registered device information as the information associated with a registered device position as a position of a registered device, the registered device corresponding to the electronic device that has been registered. The candidate determining unit identifies the registered device information for the registered device that exists at a position within a certain range from the target device based on: the registered device position managed by the information managing unit associated with the registered device information; and the target device position obtained by the target device position acquisition unit. The candidate determining unit determines the candidate based on the identified registered device information.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 illustrates a block diagram of a system according to an embodiment of the disclosure;

FIG. 2 illustrates a block diagram of an MFP according to the embodiment;

FIG. 3 illustrates a block diagram of a communication terminal according to the embodiment;

FIG. 4 illustrates a block diagram of a firmware distribution server according to the embodiment;

FIG. 5 illustrates an exemplary FW management table according to the embodiment;

FIG. 6 illustrates an exemplary usage environment setting information management table according to the embodiment;

FIG. 7 illustrates an operation of the system according to the embodiment;

FIG. 8 illustrates the operation following the operation illustrated in FIG. 7; and

FIG. 9 illustrates an exemplary candidate screen displayed in the operation illustrated in FIG. 7.

### DETAILED DESCRIPTION

Example apparatuses are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The following describes an embodiment of the disclosure with reference to the drawings.

First, a description will be given of the configuration of a system according to the embodiment.

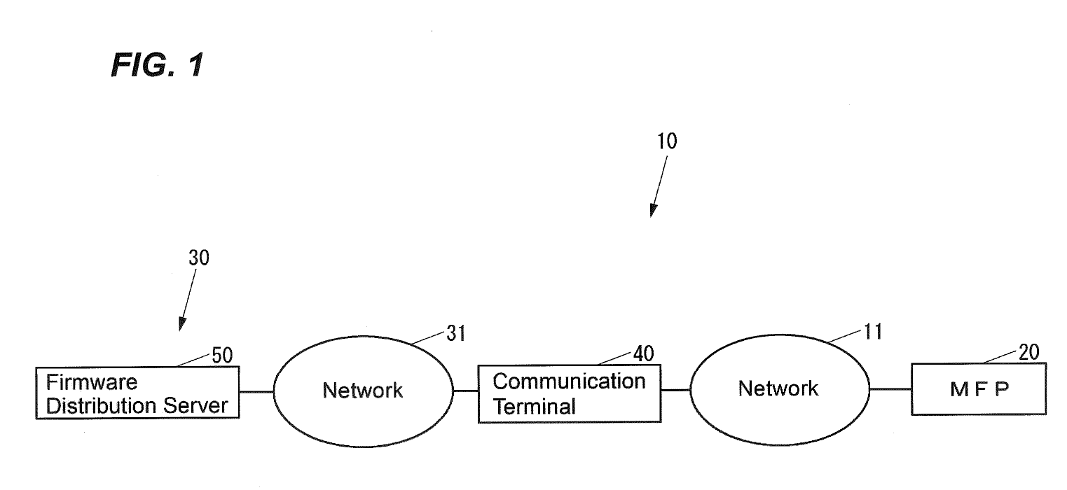

FIG. 1 illustrates a block diagram of a system 10 according to the embodiment.

As illustrated in FIG. 1, the system 10 includes a Multifunction Peripheral (MFP) 20 as an electronic device, and a firmware update system 30 as a setting execution system that updates firmware of the electronic device and applies setting information to the firmware.

Here, the firmware is varied depending on the types of electronic devices. The firmware may not have the globally common specification even if the types of electronic devices are identical. For example, the firmware may have a specifications varied depending on cultures and demands for respective regions in the world. A special purpose firmware customized for a specific user may be provided to the specific user by a provider of the MFP 20. Here, a specification describes whether specific functions are available or not, and what sort of setting enables the function when the specific functions are available. For example, the firmware may include: a setting where a specific language is set as a default language used by an electronic device; a setting where an energy saving mode that causes an electronic device to operate in an energy saving state is available in default; a setting where the energy saving mode is unavailable in default; a setting where it is mandatory that an encryption mode that causes an electronic device to perform with encrypting specific data processed in the electronic device is effective; or a setting where it is mandatory that the encryption mode is ineffective. A type of each firmware is identified with identification information (hereinafter referred to as “firmware ID”).

The firmware update system 30 includes a communication terminal 40 as a computer such as a smart phone, a tablet, and a firmware distribution server 50 as a computer such as a Personal Computer (PC) for distributing the firmware. The communication terminal 40 is carried by a service person who performs maintenance of the MFP 20. The service person is not a person as a user of the MFP 20 but a person of a provider of the MFP 20, for example, a manufacturing company of the MFP 20.

The MFP 20 and the communication terminal 40 are communicatively connected to one another via a network 11 such as a Local Area Network (LAN). The MFP 20 and the communication terminal 40 may be directly communicatively connected to one another via wired or wireless connection rather than the network 11.

The communication terminal 40 and the firmware distribution server 50 are communicatively connected to one another via a network 31 such as the Internet.

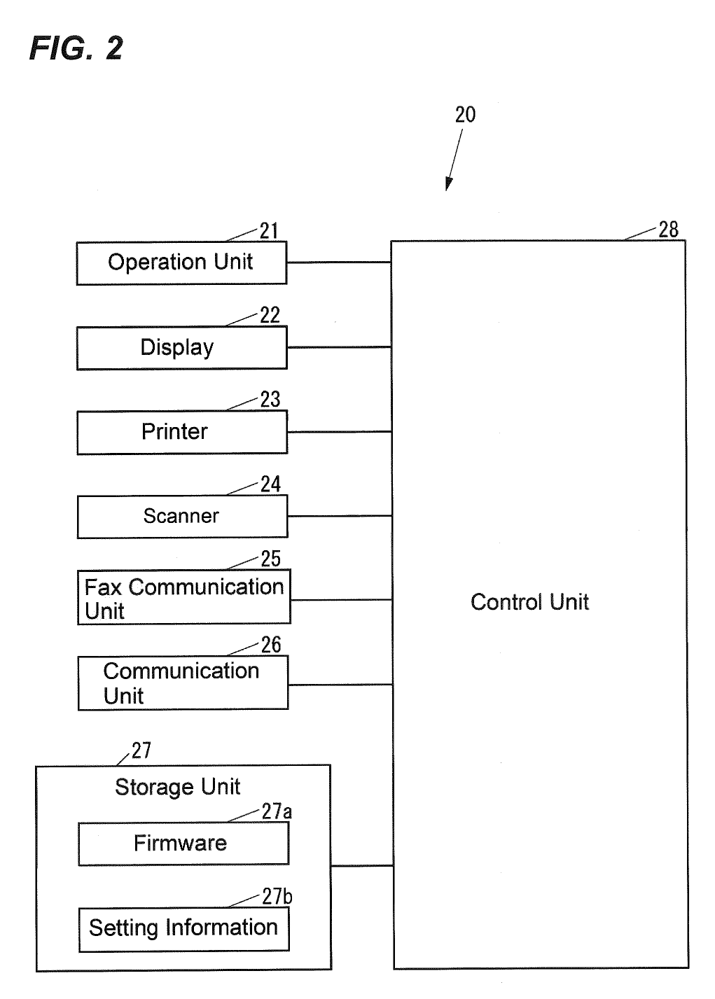

FIG. 2 illustrates a block diagram of the MFP 20.

As illustrated in FIG. 2, the MFP 20 includes an operation unit 21, a display 22, a printer 23, a scanner 24, a fax communication unit 25, a communication unit 26, a storage unit 27, and a control unit 28. The operation unit 21 is an input device such as a button with which a user inputs various kinds of operations. The display 22 is a display device such as a Liquid Crystal Display (LCD) that displays various kinds of information. The printer 23 is a print device that executes printing on a recording medium such as a paper sheet. The scanner 24 is a reading device that reads image data from an original document. The fax communication unit 25 is a fax device that performs fax communication with an external facsimile device (not illustrated) via a communication line such as a dial-up line. The communication unit 26 is a communication device that communicates with an external device via the network 11 (see FIG. 1) or via wired or wireless connection (without the network 11). The storage unit 27 is a non-volatile storage device such as a semiconductor memory or a Hard Disk Drive (HDD) that stores various data. The control unit 28 controls the entire MFP 20.

The storage unit 27 stores firmware 27a as a program for controlling the MFP 20, and setting information 27b that are applied to the MFP 20. Each of the firmware 27a and the setting information 27b may be installed into the MFP 20 at its production stage of the MFP 20, may be additionally installed into the MFP 20 from an external storage medium such as a Universal Serial Bus (USB) memory, or may be additionally installed into the MFP 20 from the network 11.

The control unit 28 is a computer that includes, for example, a Central Processing Unit (CPU), a Read Only Memory (ROM) that stores programs and various data, and a Random Access Memory (RAM) that is used as a work area for a CPU. The CPU executes the program stored in the ROM or the storage unit 27.

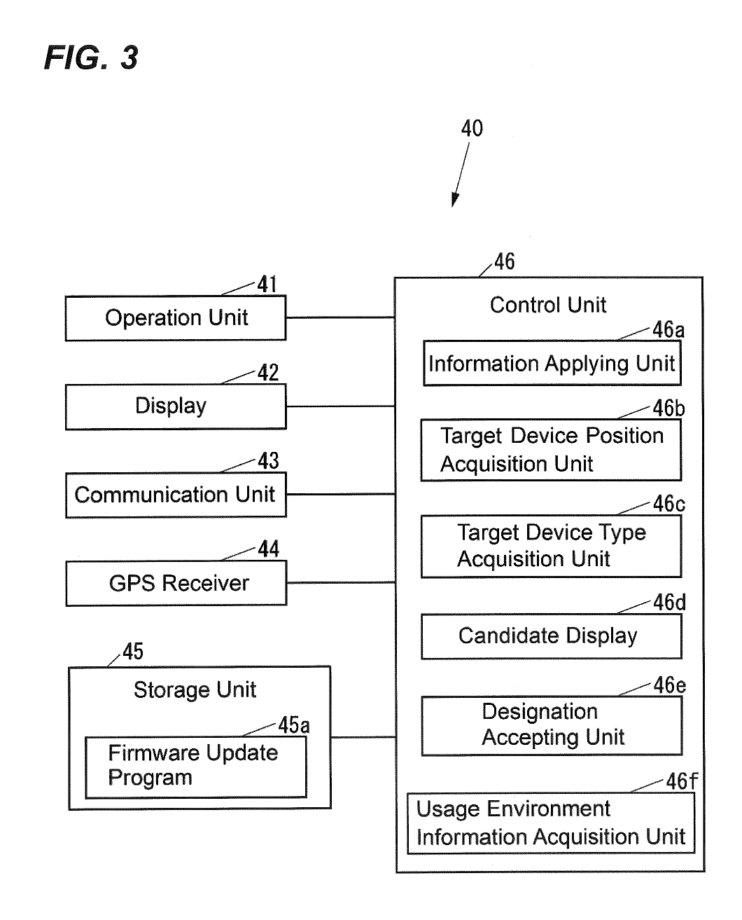

FIG. 3 illustrates a block diagram of the communication terminal 40.

As illustrated in FIG. 3, the communication terminal 40 includes an operation unit 41, a display 42, a communication unit 43, a GPS receiver 44, a storage unit 45, and a control unit 46. The operation unit 41 is an input device such as a button with which a user inputs various kinds of operations. The display 42 is a display device such as a LCD that displays various kinds of information. The communication unit 43 is a communication device that communicates with an external device via the network 11 (see FIG. 1) or the network 31 (see FIG. 1), or via wired or wireless connection without the network 11 and the network 31. The GPS receiver 44 receives a radio wave from the Global Positioning System (GPS) satellite (not illustrated) to obtain a position. The storage unit 45 is a non-volatile storage device such as a semiconductor memory or a Hard Disk Drive (HDD) that stores various data. The control unit 46 controls the entire communication terminal 40.

The storage unit 45 stores a firmware update program 45a as a setting execution program for updating firmware of the electronic device to apply setting information to the electronic device. The firmware update program 45a may be installed into the communication terminal 40 at its production stage of the communication terminal 40, may be additionally installed into the communication terminal 40 from an external storage medium such as a USB flash memory, or may be additionally installed into the communication terminal 40 from the network 11 or the network 31.

The control unit 46 includes, for example, a CPU, a ROM that stores programs and various data, and a RAM that is used as a work area of the CPU. The CPU executes the program stored in the ROM or the storage unit 45.

The control unit 46 executes the firmware update program 45a stored in the storage unit 45 to function as an information applying unit 46a, a target device position acquisition unit 46b, a target device type acquisition unit 46c, a candidate display 46d, a designation accepting unit 46e, and a usage environment information acquisition unit 46f. The information applying unit 46a applies information including firmware and setting information to the electronic device. The target device position acquisition unit 46b obtains a target device position as a position of a target device. The target device corresponds to the electronic device to which the information is applied by the information applying unit 46a. The target device type acquisition unit 46c obtains a target device type as a type of the target device. The candidate display 46d displays candidates of the information applied to the target device. The designation accepting unit 46e accepts any of a designation of the candidate displayed by the candidate display 46d. The usage environment information acquisition unit 46f obtains usage environment information indicating a usage environment of the target device.

A type of the target device is, for example, by a model number of the target device.

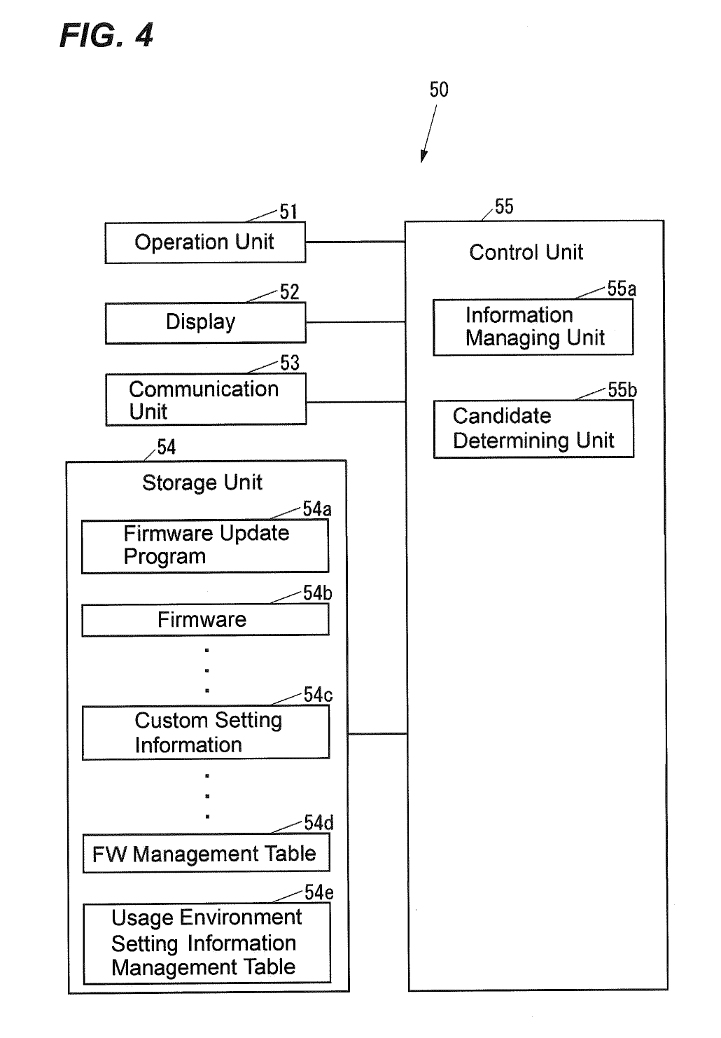

FIG. 4 illustrates a block diagram of the firmware distribution server 50.

As illustrated in FIG. 4, the firmware distribution server 50 includes an operation unit 51, a display 52, a communication unit 53, a storage unit 54, and a control unit 55. The operation unit 51 is an input device such as a computer mouse or a keyboard with which a user inputs various kinds of operations. The display 52 is a display device such as a LCD that displays various kinds of information. The communication unit 53 is a communication device that communicates with an external device via the network 31 (see FIG. 1). The storage unit 54 is a non-volatile storage device such as a semiconductor memory or an HDD that stores various data. The control unit 55 controls the entire firmware distribution server 50.

The storage unit 54 stores a firmware update program 54a as a setting execution program for updating a firmware of the electronic device to apply setting information to the electronic device. The firmware update program 54a may be installed into the firmware distribution server 50 at its production stage of the firmware distribution server 50, may be additionally installed into the firmware distribution server 50 from an external storage medium such as a USB flash memory, or may be additionally installed into the firmware distribution server 50 from the network 31.

The storage unit 54 stores a plurality of types of firmware 54b as programs for controlling the electronic device.

The storage unit 54 stores a plurality of types of custom setting information 54c customized for a registered device corresponding to the electronic device that has been registered, among setting information of the electronic devices. For example, the custom setting information 54c may include setting information corresponding to the network in which the registered device is installed, for example, a usage protocol setting and a security level setting. The custom setting information 54c may also include setting information corresponding to a user of a registered device, for example, setting for the user of the registered device and a setting of an address book.

The storage unit 54 stores an FW management table 54d that is referred for managing the firmware 54b and the custom setting information 54c.

The storage unit 54 stores a usage environment setting information management table 54e that is referred for managing usage environment setting information corresponding to a usage environment of the electronic device among setting information of the electronic device.

The control unit 55 includes, for example, a CPU, a ROM that stores programs and various data, and a RAM that is used as a work area of the CPU. The CPU executes the program stored in the ROM or the storage unit 54.

The control unit 55 executes the firmware update program 54a stored in the storage unit 54 to manage the firmware 54b and the custom setting information 54c using the FW management table 54d and function as an information managing unit 55a and a candidate determining unit 55b. The information managing unit 55a manages usage environment setting information using the usage environment setting information management table 54e. The candidate determining unit 55b determines information candidate to be applied to a target device.

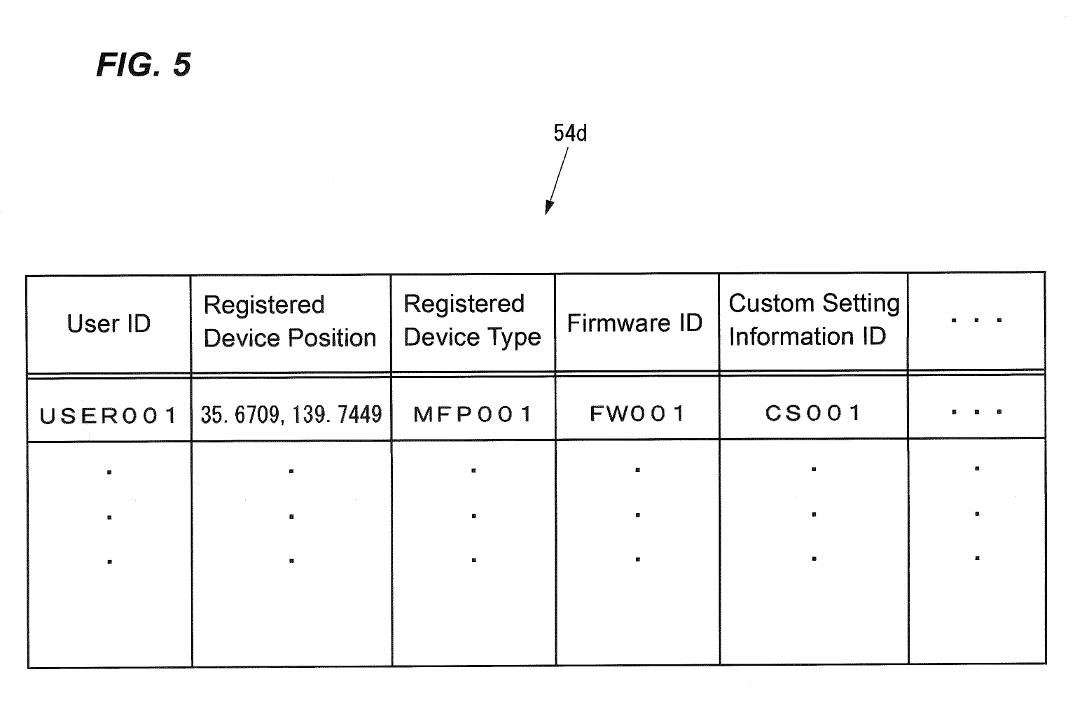

FIG. 5 illustrates an exemplary FW management table 54d.

As illustrated in FIG. 5, the FW management table 54d includes for each registered device: a user ID as identification information of the user of the registered device; a registered device position as a position of the registered device; a registered device type as a type of the registered device; a firmware ID as identification information of firmware written in the registered device; and a custom setting information ID as identification information of custom setting information applied to the registered device. For example, the FW management table 54d illustrated in FIG. 5 indicates an electronic device which is installed at a position having a latitude of “35.6709” and a longitude of “139.7449,” and has a registered device type of “MFP001,” and is belonged to a user having a user ID of “USER001,” and in which firmware having a firmware ID of “FW001” is written, and to which custom setting information having a custom setting information ID of “CS001” is applied. A combination of firmware and custom setting information corresponding to a combination of the firmware ID and the custom setting information ID included in the FW management table 54d constitutes the registered device information of the disclosure.

A registered device type is, for example, a model number of the registered device.

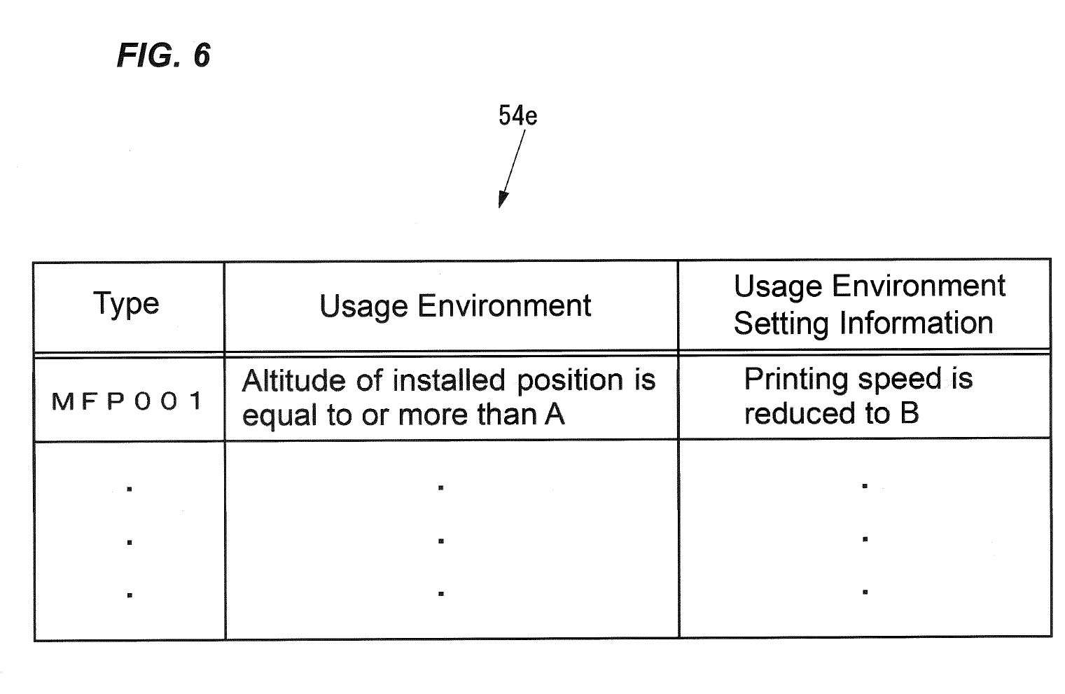

FIG. 6 illustrates an exemplary usage environment setting information management table 54e.

As illustrated in FIG. 6, the usage environment setting information management table 54e includes an electronic device type, a usage environment of the electronic device, and usage environment setting information for each combination of an electronic device type and a usage environment. For example, according to the usage environment setting information management table 54e illustrated in FIG. 6, for an electronic device of a type “MFP001,” when the usage environment is that “an altitude of an installed position is equal to or more than A,” the usage environment setting information that “a print speed is reduced to B” is applied to the electronic device. The usage environment includes not only the altitude of the install position of the electronic device but also various conditions such as a temperature and a humidity of the install position of the electronic device. The usage environment setting information includes not only the printing speed but also various conditions such as an applied voltage for charging a photoreceptor drum of a printer. In the usage environment setting information management table 54e, the usage environment setting information is specified for a specific electronic device to optimally operate in a specific usage environment.

Next, the following describes an operation of the system 10.

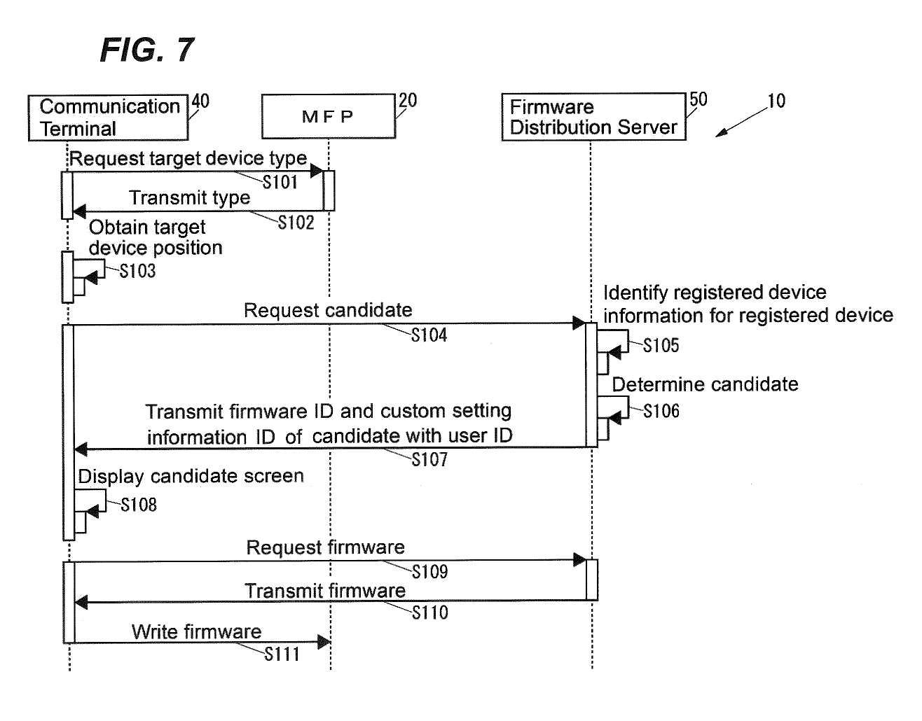

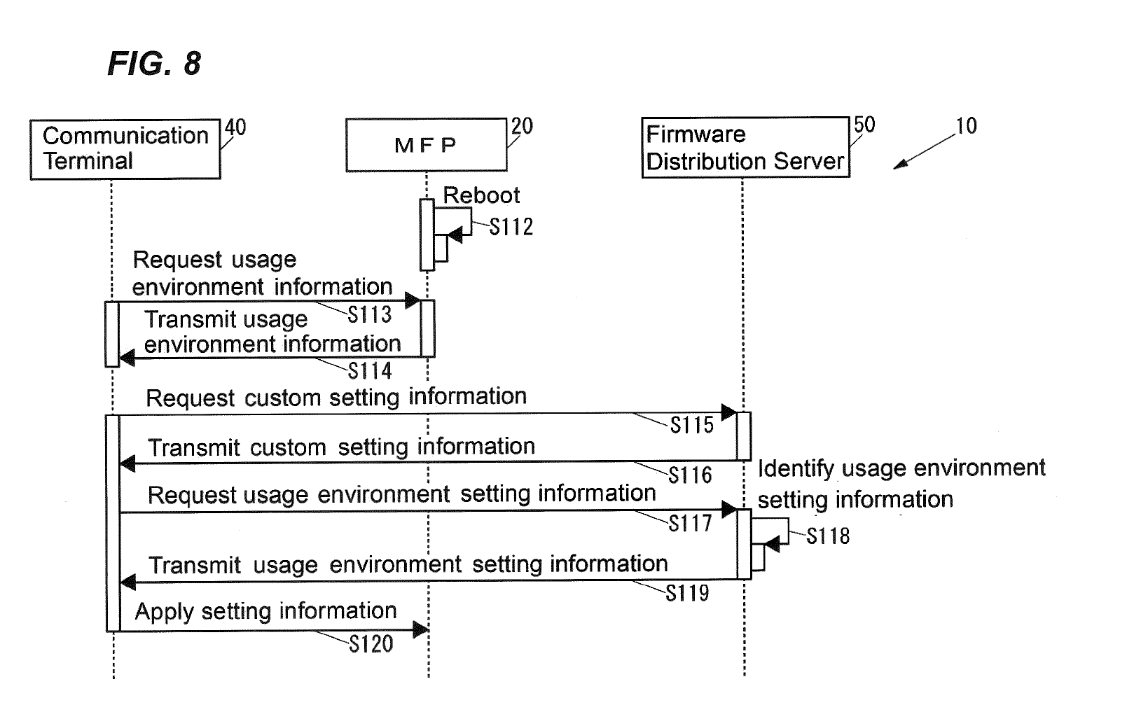

FIGS. 7 and 8 illustrate the operation of the system 10.

When a service person updates the firmware 27a of the MFP 20, the service person communicatively connects the communication terminal 40 to the MFP 20, so as to instruct the communication terminal 40 to start the update of the firmware 27a via the operation unit 41.

When the start of the update of the firmware 27a is instructed, as illustrated in FIGS. 7 and 8, the target device type acquisition unit 46c of the communication terminal 40 requests the type of the MFP 20, that is, the target device type to the MFP 20 (Step S101). Thus, the control unit 28 of the MFP 20 transmits the type of the MFP 20 to the communication terminal 40 (Step S102). Namely, the target device type acquisition unit 46c obtains the target device type from the MFP 20.

After the process of Step S102, the target device position acquisition unit 46b of the communication terminal 40 obtains a position of the MFP 20, that is, a target device position via the GPS receiver 44 (Step S103). While in the embodiment the target device position acquisition unit 46b obtains a position of the communication terminal 40 using the GPS as the position of the MFP 20, the target device position acquisition unit 46b may obtain the position of the MFP 20 using another method. For example, the target device position acquisition unit 46b may obtain the position of the MFP 20 from the MFP 20.

After the process of Step S103, the candidate display 46d of the communication terminal 40 transmits the target device type obtained in Step S102 and the target device position obtained in Step S103 to the firmware distribution server 50, so as to request candidates of firmware and custom setting information to the firmware distribution server 50 (Step S104).

Thus, the candidate determining unit 55b of the firmware distribution server 50 identifies the registered device information based on the registered device position and the registered device type stored in the FW management table 54d, and the target device position and the target device type transmitted in Step S104 (Step S105). The registered device information includes the firmware and the custom setting information for the registered device, which is identical type as the target device or the MFP 20 and exists at a position within a certain range from the MFP 20. The candidate determining unit 55b determines the candidates based on the registered device information identified in Step S105 (Step S106). For example, the candidate determining unit 55b may determine a firmware of the registered device information identified in Step S105 as one of the firmware candidates, or may determine a firmware updated from the firmware of the registered device information identified in Step S105 as one of firmware candidates. The candidate determining unit 55b may determine an ordinary firmware that is not customized as one of firmware candidates when the firmware of the registered device information identified in Step S105 is customized for a specific user. Also, the candidate determining unit 55b determines the custom setting information of the registered device information identified in Step S105 as a custom setting information candidate.

After the process of Step S106, the candidate determining unit 55b associates the firmware ID of the firmware candidate determined in Step S106 and the custom setting information ID of the custom setting information with the registered device information, based on which the candidate is determined in Step S106, that is, the firmware ID of the firmware of the registered device information identified in Step S105 and the custom setting information ID of the custom setting information of the registered device information identified in Step S105, so as to transmit them to the communication terminal 40 along with the user ID managed in the FW management table 54d (Step S107).

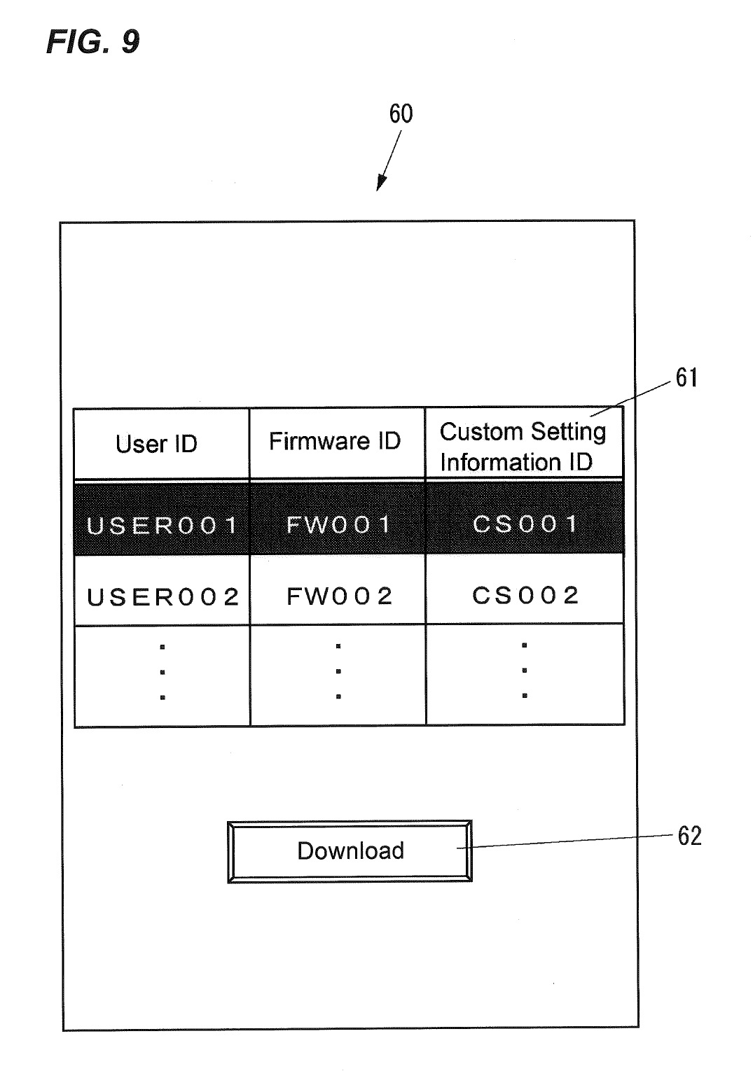

Thus, the candidate display 46d of the communication terminal 40 displays a candidate screen 60 (see FIG. 9) that displays a combination of the firmware candidate ID, the custom setting information ID received in Step S107, and the user ID on the display 42 (Step S108).

FIG. 9 illustrates an exemplary candidate screen 60 displayed on the display 42 in the operation illustrated in FIG. 7.

The candidate screen 60 illustrated in FIG. 9 includes: a candidate display area 61 that displays the combination of the firmware candidate ID, the custom setting information ID, and the user ID for each candidate; and a download button 62 for obtaining the firmware identified in the candidate display area 61 from the firmware distribution server 50. The candidate display area 61 can accept a designation of the firmware and the custom setting information to be downloaded among the displayed candidates. In the candidate display area 61, a line of the designated combination of the firmware and the custom setting information is inverted in black-and-white. In the example illustrated in FIG. 9, the combination of the firmware having a firmware ID “FW001” of the user ID “USER001” and custom setting information having the custom setting information ID “CS001” of the user ID “USER001” is designated.

As illustrated in FIGS. 7 and 8, when the download button 62 is pressed after the process of Step S108, the designation accepting unit 46e of the communication terminal 40 transmits the firmware ID of the combination of the firmware and the custom setting information designated in the candidate display area 61 at the point when the download button 62 is pressed to the firmware distribution server 50, so as to request the firmware to the firmware distribution server 50 (Step S109). Thus, the information managing unit 55a of the firmware distribution server 50 transmits the firmware 54b, which is requested by the communication terminal 40, to the communication terminal 40 (Step S110). Namely, the communication terminal 40 downloads the firmware from the firmware distribution server 50.

After the process of Step S110, the information applying unit 46a of the communication terminal 40 writes the firmware downloaded from the firmware distribution server 50 in Step S110 into the MFP 20 (Step S111). Namely, the information applying unit 46a applies the firmware downloaded from the firmware distribution server 50 to the MFP 20. Thus, the firmware 27a of the MFP 20 is updated to the firmware written in Step S111.

After the firmware 27a is updated, the control unit 28 of the MFP 20 automatically reboots the MFP 20 without receiving an instruction from the communication terminal 40, or reboots the MFP 20 with receiving an instruction from the communication terminal 40 (Step S112). The MFP 20 is rebooted to start an operation corresponding to the firmware 27a.

After the MFP 20 is rebooted, the usage environment information acquisition unit 46f of the communication terminal 40 requests the usage environment information of the MFP 20 to the MFP 20 (Step S113). Thus, the control unit 28 of the MFP 20 transmits the usage environment information, which is request from the communication terminal 40, to the communication terminal 40 (Step S114). Here, the usage environment information of the MFP 20 includes information, such as altitude, temperature, and humidity of the install position of the MFP 20. The usage environment information acquisition unit 46f may obtain the usage environment information of the MFP 20 from a source other than the MFP 20. For example, the usage environment information acquisition unit 46f may use the altitude obtained by the GPS receiver 44 as the altitude of the install position of the MFP 20.

After the process of Step S114, the information applying unit 46a of the communication terminal 40 transmits the custom setting information ID of the custom setting information, which is combined with the firmware requested to the firmware distribution server 50 in the candidate display area 61 in Step S109, to the firmware distribution server 50, so as to request the custom setting information to the firmware distribution server 50 (Step S115). Thus, the information managing unit 55a of the firmware distribution server 50 transmits the custom setting information 54c, which is requested from the communication terminal 40, to the communication terminal 40 (Step S116). Namely, the communication terminal 40 downloads the custom setting information from the firmware distribution server 50.

After the process of Step S116, the information applying unit 46a of the communication terminal 40 transmits the target device type obtained in Step S102 and the usage environment information obtained in Step S114 to the firmware distribution server 50, so as to request the usage environment setting information to the firmware distribution server 50 (Step S117). Thus, the information managing unit 55a of the firmware distribution server 50 identifies the usage environment setting information corresponding to the target device type and the usage environment based on the target device type and the usage environment information, which are transmitted from the communication terminal 40, and the usage environment setting information management table 54e (Step S118), so as to transmit the usage environment setting information identified in Step S118 to the communication terminal 40 (Step S119). Namely, the communication terminal 40 downloads the usage environment setting information from the firmware distribution server 50.

After the process of Step S119, the information applying unit 46a of the communication terminal 40 applies the custom setting information obtained in Step S116 and the usage environment setting information obtained in Step S119 to the MFP 20 (Step S120). Thus, the custom setting information and the usage environment setting information that are transmitted from the communication terminal 40 are applied to the setting information 27b of the MFP 20.

As described above, the firmware update system 30 identifies the registered device information for the registered device, which exists at a position within a certain range from the target device or the MFP 20, based on the position of the MFP 20 and the position of the registered device (Step S105), determines information candidates including the firmware and the custom setting information based on the identified registered device information (Step S106), and instructs a setting execution director, for example, the service person to designate any of the determined candidates, thus ensuring the improved appropriateness of applying the firmware and the custom setting information to the MFP 20.

Since the firmware update system 30 associates a user with the registered device information, based on which the candidate is determined, to display the user with the candidate (Step S108), the firmware update system 30 can instruct the setting execution director to designate any of the candidates corresponding to the user of the MFP 20, thus ensuring the improved appropriateness of applying the firmware and the custom setting information to the MFP 20. In particular, the GPS does not have high accuracy for obtaining a position, thus displaying a user with candidates is effective when a plurality of users exist in a relatively narrow area such as multitenant buildings. The firmware update system 30 may not display the candidates with a user.

When displaying a firmware identical to a firmware of the registered device as one of firmware candidates, the firmware update system 30 can write the firmware identical to the registered device where the firmware is already updated into the MFP 20, thus ensuring the improved appropriateness of updating the firmware of the MFP 20. For example, when an MFP is malfunctioning, and a service person provides another MFP 20, which is identical type as the MFP that is malfunctioning (hereinafter referred to as “malfunctioning machine”), as an alternative machine to the user of the malfunctioning machine for repair, the service person can appropriately write a firmware that is identical as a firmware of the malfunctioning machine into the MFP 20 if the malfunctioning machine is already registered in the FW management table 54d, thus ensuring the reduced possibility of writing incorrect firmware into the MFP 20.

When a firmware upgraded from a firmware of the registered device is displayed as one of firmware candidates, the firmware update system 30 can write the upgraded firmware into the MFP 20, which ensures the improved appropriateness of updating the firmware of the MFP 20. For example, when the MFP 20 is already registered in the FW management table 54d and the user desires to appropriately write a firmware upgraded from a firmware currently written in the MFP 20 into the MFP 20, the service person can appropriately write the firmware upgraded from the firmware currently written in the MFP 20 into the MFP 20 even if the user of the MFP 20 does not correctly aware of what sort of firmware is already provided, thus ensuring the reduced possibility for writing incorrect firmware into the MFP 20.

The firmware update system 30 can instruct the setting execution director to designate any of the candidates determined based on the registered device information for the registered device which not only exists at a position within a certain range from the MFP 20 but also is identical type as the MFP 20, thus ensuring the improved appropriateness of applying the firmware and the custom setting information to the MFP 20. The firmware update system 30 may identify the registered device information, based on which the candidates determined, without considering whether the registered device information is the registered device information for the registered device that is identical type as the MFP 20 or not.

The firmware update system 30 applies the setting information corresponding to the usage environment of the MFP 20, that is, the usage environment setting information to the MFP 20, thus ensuring the improved appropriateness of applying the setting information to the MFP 20.

The firmware update system 30 may identify only registered device information including the customized firmware in Step S105. For example, when the FW management table 54d manages only registered device information including the customized firmware, the firmware update system 30 identifies only the registered device information including the customized firmware in Step S105.

While in the embodiment the firmware update system 30 displays the candidate screen 60 including the custom setting information ID, the candidate screen 60 may not include the custom setting information ID.

In the firmware update system 30, at least a part of the function of the above-described firmware distribution server 50 may be included in the communication terminal 40 rather than in the firmware distribution server 50, or at least a part of the function of the above-described communication terminal 40 may be included in the firmware distribution server 50 rather than in the communication terminal 40. For example, when all the functions of the above-described firmware distribution server 50 is included in the communication terminal 40 rather than in the firmware distribution server 50, that is, when the control unit 46 of the communication terminal 40 executes the firmware update program 45a to function as an information managing unit and a candidate determining unit, it is not necessary that the firmware update system 30 includes the firmware distribution server 50 but may include only the communication terminal 40.

After updating the firmware of the MFP 20, the firmware update system 30 automatically applies the custom setting information for the updated firmware to the MFP 20, thus ensuring the improved convenience. For example, when the MFP 20 includes a plurality of cassettes including a first cassette and a second cassette as sheet feed cassettes and the second cassette is set in the MFP 20 as a default sheet feed cassette before the update of the firmware, and even if the firmware is updated to a firmware that changes the default sheet feed cassette to the first cassette, the firmware update system 30 can automatically apply custom setting information, which sets the second cassette as a default sheet feed cassette, to the MFP 20. When the update of the firmware creates a function that cannot be used without applying new custom setting information such as the setting of the network, the firmware update system 30 can automatically apply such custom setting information to the MFP 20 after the update of the firmware. While the setting execution system of the disclosure applies the setting information to the target device after updating the firmware of the target device in the embodiment, the setting execution system may apply the setting information to the target device without updating the firmware of the target device.

While the electronic device of the disclosure is an MFP in the embodiment, the electronic device may be an image forming apparatus other than an MFP such as a printer-only machine, a copy-only machine, a FAX-only machine, or an electronic device other than an image forming apparatus such as a PC.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A setting execution system comprising:
an information applying unit that applies information including setting information that indicates a setting for an electronic device to the electronic device;
an information managing unit that manages the information;
a target device position acquisition unit that obtains a target device position as a position of a target device, the target device corresponding to the electronic device to which the information is applied by the information applying unit;
a candidate determining unit that determines a candidate of the information applied to the target device;
a candidate display that displays the candidate determined by the candidate determining unit; and
a designation accepting unit that accepts any of designation of the candidates displayed by the candidate display;
wherein the information applying unit applies the candidate corresponding to the designation accepted by the designation accepting unit to the target device,
the information managing unit manages registered device information as the information associated with a registered device position as a position of a registered device, the registered device corresponding to the electronic device that has been registered,
the candidate determining unit identifies the registered device information for the registered device that exists at a position within a certain range from the target device based on:
the registered device position managed by the information managing unit associated with the registered device information; and
the target device position obtained by the target device position acquisition unit, and
the candidate determining unit determines the candidate based on the identified registered device information.

2. The setting execution system according to claim 1,
wherein the information managing unit manages registered device information as the information also associated with a user of the registered device, and
the candidate display displays, with the candidate, the user managed by the information managing unit associated with the registered device information, based on which the candidate is determined.

3. The setting execution system according to claim 1, further comprising:
a target device type acquisition unit that obtains a target device type as a type of the target device,
wherein the information managing unit manages the registered device information associated with a registered device type as a type of the registered device,
the candidate determining unit identifies the registered device information for the registered device identical type as the target device and exists at a position within a certain range from the target device based on:
the registered device position and the registered device type managed by the information managing unit associated with the registered device information;
the target device position obtained by the target device position acquisition unit; and
the target device type obtained by the target device type acquisition unit.

4. The setting execution system according to claim 3, further comprising:
a usage environment information acquisition unit that obtains usage environment information indicating a usage environment of the target device,
wherein the information managing unit manages usage environment setting information indicating a setting of the electronic device corresponding to a usage environment of the electronic device associated with a type of the electronic device and a usage environment, and
the information managing unit identifies the usage environment setting information corresponding to the type and usage environment of the target device based on:
the type and usage environment of the electronic device that are managed by the information managing unit associated with the usage environment setting information;
the target device type that is obtained by the target device type acquisition unit; and
the usage environment information that is obtained by the usage environment information acquisition unit,
wherein the information applying unit applies the usage environment setting information that is identified by the information managing unit to the target device.

5. The setting execution system according to claim 1,
wherein the registered device information includes firmware of the registered device, and
the information applying unit applies the firmware included in the candidate corresponding to the designation accepted by the designation accepting unit to the target device and then applies the setting information included in this candidate to the target device

6. A non-transitory computer-readable recording medium storing a setting execution program executable by a computer, the setting execution program causing a computer to operate as:
an information applying unit that applies information including setting information that indicates a setting for an electronic device to the electronic device;
an information managing unit that manages the information;
a target device position acquisition unit that obtains a target device position as a position of a target device, the target device corresponding to the electronic device to which the information is applied by the information applying unit;
a candidate determining unit that determines a candidate of the information applied to the target device;
a candidate display that displays the candidate determined by the candidate determining unit; and
a designation accepting unit that accepts any of designation of the candidates displayed by the candidate display;
wherein the information applying unit applies the candidate corresponding to the designation accepted by the designation accepting unit to the target device,
the information managing unit manages registered device information as the information associated with a registered device position as a position of a registered device, the registered device corresponding to the electronic device that has been registered,
the candidate determining unit identifies the registered device information for the registered device that exists at a position within a certain range from the target device based on:
the registered device position managed by the information managing unit associated with the registered device information; and
the target device position obtained by the target device position acquisition unit, and
the candidate determining unit determines the candidate based on the identified registered device information.
